(19) United States
(12) Patent Application Publication
(10) Pub. No.: US 2023/0023878 A1
(43) Pub. Date: Jan. 26, 2023

(54) EQUIPMENT STATE MONITORING DEVICE AND EQUIPMENT STATE MONITORING METHOD

(71) Applicant: Mitsubishi Electric Corporation, Tokyo (JP)

(72) Inventor: Toshiyuki KURIYAMA, Tokyo (JP)

(73) Assignee: Mitsubishi Electric Corporation, Tokyo (JP)

(21) Appl. No.: 17/961,903

(22) Filed: Oct. 7, 2022

Related U.S. Application Data
(63) Continuation of application No. PCT/JP2020/021206, filed on May 28, 2020.

(51) Int. Cl. G05B 23/02

(52) U.S. Cl. CPC G05B 23/0213; G05B 2223/02

(57) ABSTRACT

An equipment state monitoring device includes: a feature amount extracting unit to extract a feature amount of operation data in which a state of equipment is measured; an operation pattern determining unit to determine whether an operation pattern of the equipment when the operation data is measured is a learned pattern in which a determination range of a state of the equipment is learned or an unlearned pattern; a feature amount correcting unit to correct the feature amount of the operation data corresponding to the operation pattern determined as the unlearned pattern to correspond to the learned pattern on a basis of a relationship between an operation pattern of the equipment and a feature amount of operation data; and an equipment state determining unit to determine a state of the equipment on a basis of the corrected feature amount and a determination range of a state of the equipment.

### CROSS REFERENCE TO RELATED APPLICATIONS

This application is a Continuation of PCT International Application No. PCT/JP2020/021206, filed on May 28, 2020, which is hereby expressly incorporated by reference into the present application.

### TECHNICAL FIELD

The present disclosure relates to an equipment state monitoring device and an equipment state monitoring method.

### BACKGROUND ART

As for a conventional technique of monitoring a state of equipment, there is a technique of calculating a normal range of a state of equipment on the basis of operation data in which a normal state of the equipment is measured, and monitoring the state of the equipment on the basis of a degree of deviation of the state of the equipment from the normal range. For example, Patent Literature 1 discloses a plant diagnosis device that diagnoses that a plant is in a normal state when a measurement signal obtained by measuring a state quantity of the plant is classified as a normal model, and diagnoses that the plant is in an unknown state that has not been experienced in the past when the measurement signal is not classified as a normal model.

### CITATION LIST

### Patent Literatures

Patent Literature 1: International Publication No. 2012/073289

### SUMMARY OF INVENTION

### Technical Problem

In a case where the measurement signal is not classified into the normal range of the state of the plant, the plant diagnosis device described in Patent Literature 1 diagnoses that the plant in which the measurement signal is measured is in an unknown state. For this reason, for example, in a case where the operation data of equipment is not classified into a state learned in advance, it is determined to be in an unknown state, and thus there is a problem that the state of equipment, such as whether the equipment is in a normal state, an abnormal state, or an abnormal sign state, cannot be determined.

The present disclosure solves the above problem, and an object of the present disclosure is to obtain an equipment state monitoring device and an equipment state monitoring method capable of determining a state of equipment even using operation data corresponding to an operation pattern in which a determination range of the state of equipment is not yet learned.

### Solution to Problem

An equipment state monitoring device according to the present disclosure includes: feature amount extracting circuitry to extract a feature amount of operation data in which a state of equipment is measured; operation pattern determining circuitry to determine whether an operation pattern of the equipment when the operation data of the equipment is measured is a learned pattern in which a determination range of a state of the equipment is learned or an unlearned pattern in which a determination range of a state of the equipment is not learned; feature amount correcting circuitry to correct a distribution of the feature amount of the operation data corresponding to the operation pattern determined as the unlearned pattern in such a way as to get closer to and overlap with a distribution of a feature amount of operation data corresponding to the learned pattern on a basis of a relationship between one or more operation patterns of the equipment and one or more feature amounts of one or more pieces of operation data; and equipment state determining circuitry to determine a state of the equipment on a basis of the corrected feature amount of the operation data and a corresponding determination range of a state of the equipment.

### Advantageous Effects of Invention

According to the present disclosure, the feature amount of the operation data of the equipment corresponding to the unlearned pattern is corrected in such a way as to correspond to the learned pattern on the basis of the relationship between the operation pattern of the equipment and the feature amount of the operation data, and the state of the equipment is determined on the basis of the corrected feature amount of the operation data and the determination range of the state of the equipment. As a result, the equipment state monitoring device according to the present disclosure can determine the state of the equipment even using the operation data corresponding to the operation pattern in which the determination range of the state of the equipment is unlearned.

### BRIEF DESCRIPTION OF DRAWINGS

FIG. 1 is a block diagram illustrating a configuration of an equipment state monitoring device according to a first embodiment.

FIG. 2 is a flowchart illustrating an equipment state monitoring method according to the first embodiment.

FIG. 3 is a schematic diagram illustrating a feature amount distribution of operation data of equipment and a determination range of a state of the equipment.

FIG. 4 is a flowchart illustrating a first example of processing of correcting a feature amount of operation data corresponding to an unlearned pattern.

FIG. 5 is a graph illustrating a relationship between an operation pattern command value of equipment and a feature amount of operation data.

FIG. 6 is a graph illustrating an outline of test data correction processing in a relationship between an operation pattern command value of equipment and a feature amount of operation data.

FIG. 7 is a schematic diagram illustrating processing of correcting a difference, in a feature amount distribution of operation data corresponding to an unlearned pattern, from a feature amount distribution of operation data corresponding to a learned pattern.

FIG. 8 is a flowchart illustrating a second example of processing of correcting a feature amount of operation data corresponding to an unlearned pattern.

FIG. 9A is a graph illustrating a distribution of operation data calculated in a process (1) of correction processing using a physical model, FIG. 9B is a graph illustrating a distribution of operation data calculated in a process (2) of correction processing using a physical model, FIG. 9C is a graph illustrating a distribution of operation data calculated in a process (3) of correction processing using a physical model, and FIG. 9D is a graph illustrating a distribution of operation data calculated in a process (4) of correction processing using a physical model.

FIG. 10A is a block diagram illustrating a hardware configuration for implementing the functions of the equipment state monitoring device according to the first embodiment, and FIG. 10B is a block diagram illustrating a hardware configuration for executing software for implementing the functions of the equipment state monitoring device according to the first embodiment.

FIG. 11 is a block diagram illustrating a configuration of a modification of the equipment state monitoring device according to the first embodiment.

### DESCRIPTION OF EMBODIMENTS

### First Embodiment

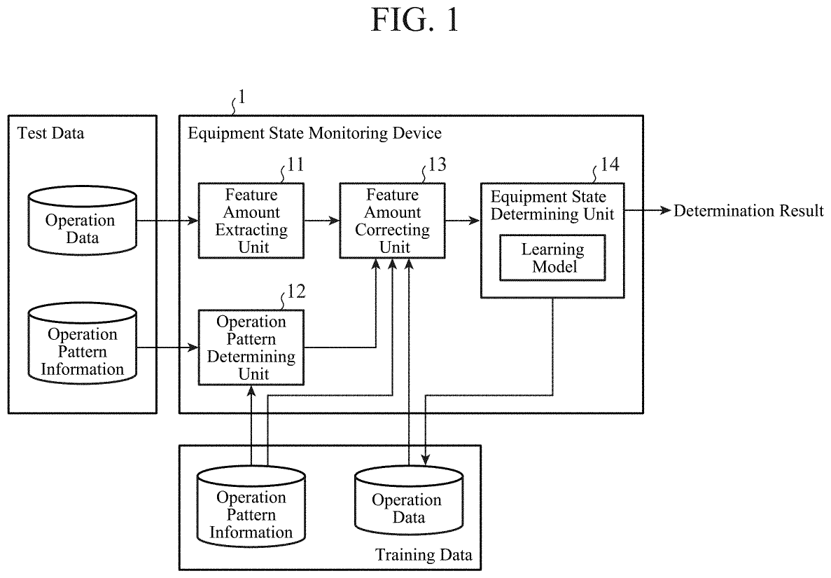

FIG. 1 is a block diagram illustrating a configuration of an equipment state monitoring device according to a first embodiment. In FIG. 1, an equipment state monitoring device 1 monitors a state of equipment, using operation data obtained by measuring the state of the equipment measured by a sensor mounted on the equipment. The equipment to be monitored is equipment that repeats a series of operations indicated by an instructed operation pattern, and is, for example, an industrial robot. The operation pattern is a series of operations determined in advance, and is executed by setting a command value indicating individual operation (for example, acceleration, deceleration, or constant speed) in the equipment. The command value of the operation pattern includes, for example, a command speed, a command position, or a command load.

The operation data measured from the equipment operating in a certain operation pattern is time-series data of the measurement value of the state of the equipment, and has a physical relationship with the command value of the operation pattern. For example, when the equipment to be monitored is an industrial robot having a rotation mechanism and the industrial robot operates in an operation pattern in which the rotation mechanism is rotated at a constant speed, a relationship between a command speed value indicating the constant speed for rotating the rotation mechanism and an average value of the torque of the rotation mechanism rotated at the command speed value can be expressed by a monotonically increasing function. A feature amount of the operation data includes, for example, a general statistic such as an average value, a minimum value, a maximum value, a variance, or a standard deviation of measurement values indicated by the operation data, or a power spectrum obtained by performing a fast Fourier transform (FFT).

As described above, the equipment state monitoring device 1 is effective for monitoring the state of the equipment in which a physical relationship appears between the operation pattern and the feature amount of the operation data. In a conventional method of monitoring a state of equipment, generally, a normal range, an abnormal range, and an abnormal sign range of the state of the equipment are learned using operation data in which the state of the equipment is measured as training data, and the state of the equipment is determined depending on to which range a feature amount (for example, the average value) of the operation data belongs.

In control equipment such as an industrial robot, an operation pattern may be changed when a product manufactured by the equipment is changed or a specification thereof is changed. In this case, there is a possibility that the operation data measured for monitoring the state of the equipment operating with the changed operation pattern is not included in any range learned in advance. In the conventional method, when the operation data is not classified into any of the learned ranges in this way, there is a possibility that the equipment is determined to be in an unknown state or the equipment is erroneously determined to be in an abnormal state even when the equipment is normal.

Therefore, by focusing on the fact that a physical relationship is established between the command value of the operation pattern of the equipment and the feature amount of the operation data, even when the operation pattern is different from a learned pattern, for example, is an operation pattern in which a determination range of a state of the equipment is unlearned (hereinafter, described as an unlearned pattern), the equipment state monitoring device 1 can correct the feature amount of the operation data corresponding o the operation pattern in such a way as to correspond to an operation pattern in which a determination range of a state of the equipment is learned (hereinafter, described as a learned pattern). As a result, the equipment state monitoring device 1 can determine the state of the equipment, on the basis of the feature amount of the operation data corresponding to the unlearned pattern and the determination range of the state of the equipment.

The equipment state monitoring device 1 generates, for each operation pattern indicated by operation pattern information, a learning model in which the determination range of the state of the equipment is learned using the operation pattern information and the operation data corresponding thereto included in the training data. For example, a one-class SVM is used to calculate the determination range. The equipment state monitoring device 1 selects a learning model corresponding to the operation pattern included in the test data from among the generated learning models, and determines the state of the equipment indicated by the operation data by inputting the feature amount of the operation data to the selected learning model. The test data includes operation data measured by the sensor from the equipment to be monitored and the operation pattern information corresponding thereto.

When determining that the operation pattern included in the test data is an unlearned pattern, the equipment state monitoring device 1 corrects the feature amount of the operation data corresponding to the unlearned pattern in such a way as to correspond to the learned pattern on the basis of the relationship between the operation pattern of the equipment and the feature amount of the operation data. Then, the equipment state monitoring device 1 determines the state of the equipment on the basis of the corrected feature amount of the operation data and the determination range of the state of the equipment.

As illustrated in FIG. 1, the equipment state monitoring device 1 includes a feature amount extracting unit 11, an operation pattern determining unit 12, a feature amount correcting unit 13, and an equipment state determining unit 14. The feature amount extracting unit 11 extracts a feature amount of the operation data in which the state of the equipment is measured. For example, the feature amount extracting unit 11 receives as input operation data measured for each constant measurement cycle from equipment by a sensor, and calculates a feature amount of the input operation data for each measurement cycle. The feature amount of the operation data is, for example, a statistic such as an average value, a minimum value, a maximum value, or a variance of the operation data measured within the time of the measurement cycle, or a power spectrum obtained by performing FFT.

The operation pattern determining unit 12 determines whether the operation pattern of the equipment when the operation data of the equipment is measured is a learned pattern in which the determination range of the state of the equipment is learned or an unlearned pattern in which the determination range of the state of the equipment is not learned. For example, by collating the operation pattern information included in the test data with the operation pattern information included in the training data, the operation pattern determining unit 12 determines, among the operation pattern information included in the test data, operation pattern information that does not match the operation pattern information included in the training data as an unlearned pattern.

The feature amount correcting unit 13 corrects the feature amount of the operation data corresponding to the operation pattern determined as the unlearned pattern in such a way as to correspond to the learned pattern on the basis of the relationship between the operation pattern of the equipment and the feature amount of the operation data. For example, the feature amount correcting unit 13 learns the relationship between the operation pattern and the feature amount of the operation data of the equipment, using the test data and the training data. On the basis of the learned relationship, the feature amount correcting unit 13 corrects the feature amount of the operation data corresponding to the operation pattern determined as the unlearned pattern in such a way as to correspond to the learned pattern. In addition, the feature amount correcting unit 13 may estimate the operation data of the equipment corresponding to the unlearned pattern using the physical model of the equipment, and correct the feature amount of the estimated operation data in such a way as to correspond to the learned pattern on the basis of the relationship between the learned pattern and the feature amount of the operation data.

The equipment state determining unit 14 determines the state of the equipment on the basis of the feature amount of the operation data of the equipment and the determination range of the state of the equipment. For example, the equipment state determining unit 14 acquires a learning model in which the determination range of the state of the equipment is learned in advance, and inputs the operation data of the equipment included in the test data to the acquired learning model. The learning model determines whether the state of the equipment indicated by the input operation data belongs to a normal range, an abnormal range, or an abnormal sign range. The equipment state determining unit 14 outputs a determination result of the state of the equipment by the learning model.

An equipment state monitoring method according to the first embodiment is as follows.

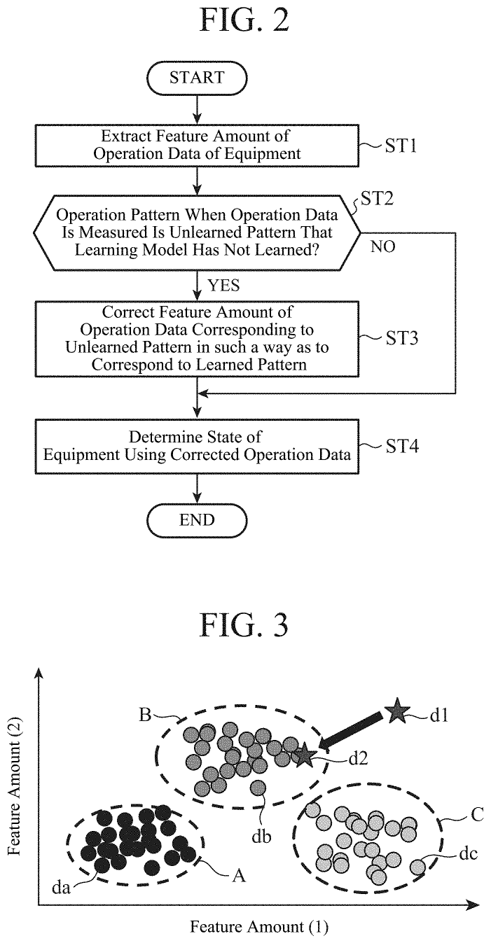

FIG. 2 is a flowchart illustrating the equipment state monitoring method according to the first embodiment, and illustrates a series of processes executed by the equipment state monitoring device 1. First, the feature amount extracting unit 11 extracts a feature amount of the operation data in which the state of the equipment is measured (step ST1). For example, the feature amount extracting unit 11 receives as input the operation data of the equipment included in the test data, and calculates the feature amount of the input operation data for each measurement cycle.

The operation pattern determining unit 12 determines whether or not the operation pattern included in the test data is an unlearned pattern (step ST2). If it is determined that the operation pattern included in the test data is a learned pattern (step ST2; NO), the equipment state monitoring device 1 proceeds to the processing of step ST4. If it is determined that the operation pattern included in the test data is an unlearned pattern (step ST2; YES), the feature amount correcting unit 13 corrects the feature amount of the operation data corresponding to the operation pattern determined as the unlearned pattern in such a way as to correspond to the learned pattern on the basis of the relationship between the operation pattern of the equipment and the feature amount of the operation data (step ST3).

The equipment state determining unit 14 determines the state of the equipment on the basis of the feature amount of the operation data of the equipment and the determination range of the state of the equipment (step ST4). For example, when it is determined that the operation pattern included in the test data is the learned pattern, the equipment state determining unit 14 inputs the feature amount of the operation data corresponding to this operation pattern to the learning model. The learning model determines whether the state of the equipment indicated by the input operation data belongs to a normal range, an abnormal range, or an abnormal sign range. When it is determined that the operation pattern included in the test data is the unlearned pattern, the corrected feature amount of the operation data is input to the learning model, and the state of the equipment is determined.

FIG. 3 is a schematic diagram illustrating a feature amount distribution of the operation data of equipment and a determination range of the state of the equipment. In FIG. 3, a feature amount (1) and a feature amount (2) are feature amounts of operation data measured from one or more pieces of equipment operating in a common operation pattern. For example, when the operation data is a torque of a rotation mechanism, the feature amount (1) may be an average value of the torque, or the feature amount (2) may be a standard deviation of the torque. Ranges A, B, and C are determination ranges of the state of equipment, the range A indicates a normal range of the equipment, the range B indicates a sign range in which the equipment becomes abnormal, and the range C indicates an abnormal range of the equipment.

The ranges A, B, and C are learned in advance using training data. For example, a feature amount da of the operation data measured from the equipment in the normal state belongs to the range A. A feature amount db of the operation data measured from the equipment indicating the sign of becoming the abnormal state belongs to the range B. A feature amount dc of the operation data measured from the equipment in the abnormal state belongs to the range C.

When a feature amount d1 of the operation data that does not belong to any of the ranges A, B, and C is obtained as the test data, the operation pattern determining unit 12 determines that the operation pattern corresponding to the feature amount d1 of the operation data is the unlearned pattern. In this case, the feature amount correcting unit 13 corrects the feature amount d1 of the operation data in such a way as to belong to any one of the ranges A, B, and C corresponding to the learned pattern. For example, the feature amount correcting unit 13 determines that the distance between the feature amount d1 of the operation data and the range B is the shortest on the basis of the relationship between the operation pattern of the equipment and the feature amount of the operation data, and corrects the feature amount d1 of the operation data to a feature amount d2 of the operation data in the range B. As a result, the equipment from which the feature amount d1 of the operation data is obtained is determined to be in the sign state of becoming the abnormal state.

Details of the processing of correcting the feature amount of the operation data of the equipment are as follows.

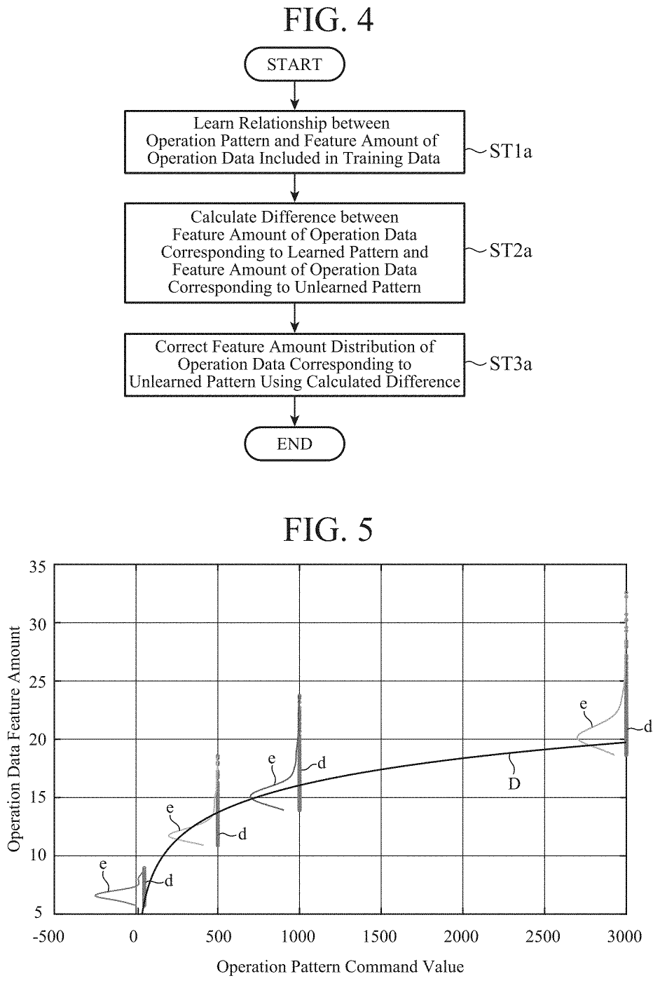

FIG. 4 is a flowchart illustrating a first example of processing of correcting a feature amount of operation data corresponding to an unlearned pattern, and illustrates a series of processes performed by the feature amount correcting unit 13. The feature amount correcting unit 13 learns the relationship between the operation pattern of the equipment and the feature amount of the operation data included in the training data (step ST1a). In the equipment to be monitored by the equipment state monitoring device 1, a physical relationship is established between the command value of the operation pattern and the feature amount of the operation data. FIG. 5 is a graph illustrating a relationship between the operation pattern command value of the equipment and the feature amount of the operation data. For example, in an operation pattern in which a rotation mechanism included in an industrial robot rotates at a constant speed, an average value of torque of the rotation mechanism monotonically increases with respect to a command speed value indicating each rotation speed.

In FIG. 5, operation data d of the equipment is time-series data of the measurement value of the state of the equipment corresponding to the operation pattern command value of the learned pattern, and a distribution e is formed for each operation pattern command value. For example, when the operation pattern command value is 500 (rpm), the operation data d is time-series data of the torque measured from the rotation mechanism rotating at 500 (rpm). A regression curve D is estimated by applying the least squares method to the average value of the operation data d for each operation pattern command value calculated from the distribution e of the operation data d. As illustrated in FIG. 5, the regression curve D is a function in which the feature amount of the operation data monotonically increases with respect to the operation pattern command value. The feature amount correcting unit 13 learns the regression curve D as described above using the training data.

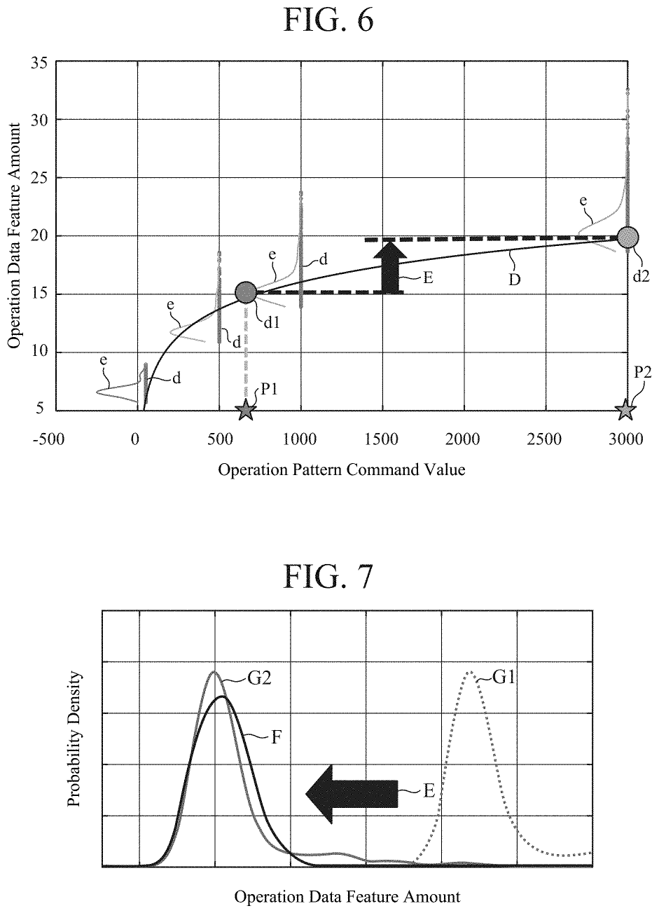

Next, the feature amount correcting unit 13 calculates a difference between the feature amount of the operation data corresponding to the learned pattern and the feature amount of the operation data corresponding to the unlearned pattern (step ST2a). FIG. 6 is a graph illustrating an outline of test data correction processing in the relationship between the operation pattern command value of the equipment and the feature amount of the operation data d. For example, in FIG. 6, since an operation pattern command value P1 included in the test data is not included in any operation pattern command value indicating a learned pattern, the operation pattern command value P1 is a command value indicating an unlearned pattern.

The feature amount correcting unit 13 determines that a point on the regression curve D corresponding to the operation pattern command value P1 as an unlearned pattern is the feature amount d1 of the operation data corresponding to the operation pattern command value P1. Subsequently, the feature amount correcting unit 13 specifies an operation pattern command value P2 among the learned patterns, and determines the feature amount d2 of the operation data that is a point on the regression curve D corresponding to the operation pattern command value P2. A relationship indicated by the regression curve D is established between the operation pattern command value P1 and the feature amount d1 of the operation data corresponding thereto, and a relationship indicated by the regression curve D is established between the operation pattern command value P2 and the feature amount d2 of the operation data corresponding thereto. As a result, the feature amount correcting unit 13 calculates a difference E between the feature amount d1 of the operation data and the feature amount d2 of the operation data.

Subsequently, the feature amount correcting unit 13 corrects the feature amount distribution of the operation data corresponding to the unlearned pattern using the calculated difference E (step ST3a). FIG. 7 is a schematic diagram illustrating processing of correcting a difference, in the feature amount distribution of the operation data corresponding to the unlearned pattern, from the feature amount distribution of the operation data corresponding to the learned pattern. As illustrated in FIG. 7, it is assumed that there are a distribution G1 of the feature amount d1 of the operation data corresponding to the operation pattern command value P1 that is the unlearned pattern and a distribution F of the feature amount d2 of the operation data corresponding to the operation pattern command value P2 that is the learned pattern.

The feature amount correcting unit 13 corrects the distribution G1 to a distribution G2, by bringing the distribution G1 of the feature amount d1 of the operation data closer to the distribution F of the feature amount d2 of the operation data, by the difference E between the distribution G1 of the feature amount d1 of the operation data and the distribution F of the feature amount d2 of the operation data. The equipment state determining unit 14 compares the distribution G2 with the distribution F, and determines the state of the equipment on the basis of the comparison result.

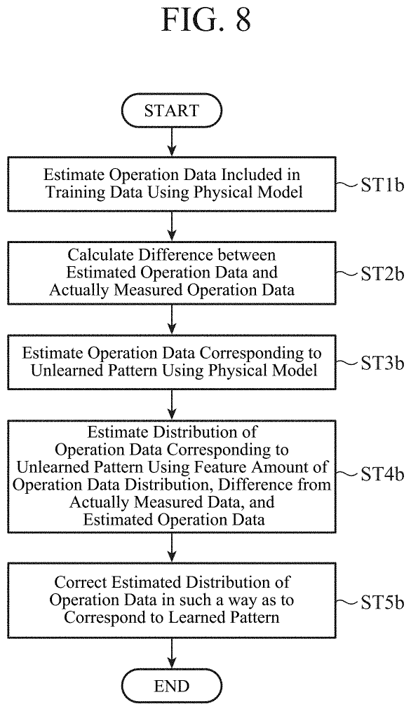

FIG. 8 is a flowchart illustrating a second example of processing of correcting the feature amount of the operation data corresponding to the unlearned pattern, and illustrates a series of processes by the feature amount correcting unit 13.

The feature amount correcting unit 13 estimates the operation data included in the training data using the physical model of the equipment (step ST1b). The physical model receives as input an operation pattern command value, and estimates operation data corresponding to the input operation pattern command value. The feature amount correcting unit 13 inputs an operation pattern command value indicating the learned pattern to the physical model, and operation data corresponding to the input learned pattern is output from the physical model.

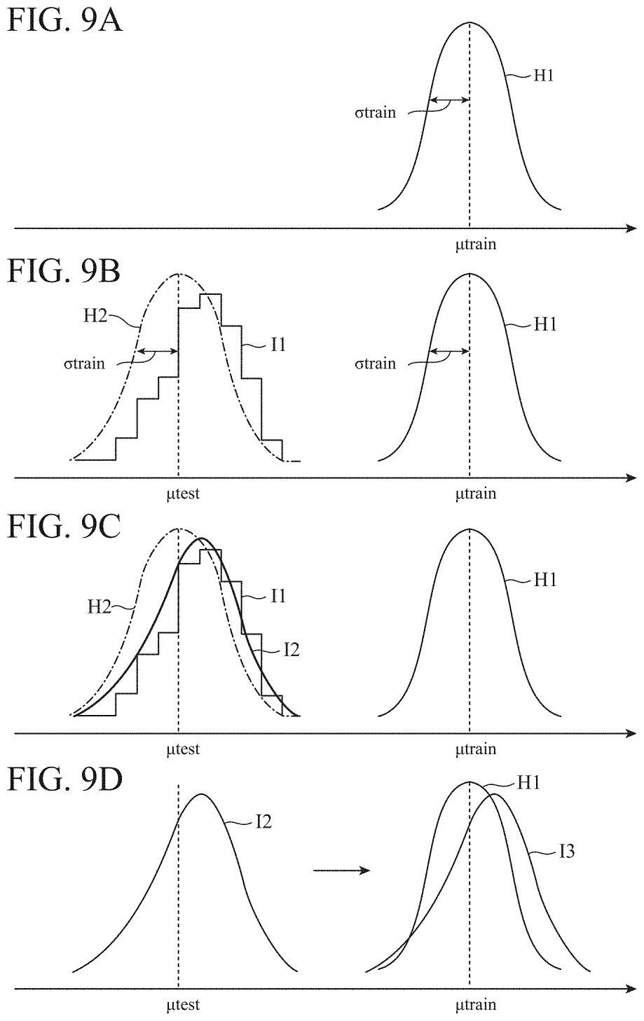

Further, the feature amount correcting unit 13 calculates a feature amount of the distribution of the estimated operation data. FIG. 9A is a graph illustrating a distribution of the operation data calculated in the process (1) of the correction processing using the physical model, and illustrates a distribution H1 of the operation data which corresponds to the learned pattern and is estimated using the physical model. For example, the feature amount correcting unit 13 calculates an average value μₜᵣₐᵢₙ and a standard deviation σₜᵣₐᵢₙ in the distribution H1 of the estimated operation data corresponding to the learned pattern. Subsequently, the feature amount correcting unit 13 calculates a difference Δd between the estimated operation data corresponding to the learned pattern and the operation data actually measured from the one or more pieces of equipment operating in the common learned pattern (step ST2b).

Next, the feature amount correcting unit 13 estimates the operation data corresponding to the unlearned pattern using the physical model of the equipment (step ST3b). For example, the feature amount correcting unit 13 inputs an operation parameter command value indicating an unlearned pattern to the physical model, and operation data corresponding to the input unlearned pattern is output from the physical model. FIG. 9B is a graph illustrating a distribution of the operation data calculated in a process (2) of the correction processing using the physical model. The feature amount correcting unit 13 calculates an average value μₜₑₛₜ of the estimated operation data corresponding to the unlearned pattern. Then, as illustrated in FIG. 9B, the feature amount correcting unit 13 generates a distribution H2 in which the average value μtrain in the distribution H1 of the operation data corresponding to the learned pattern is replaced with the average value μₜₑₛₜ. A distribution I1 is a distribution of operation data actually measured from equipment operating in an unlearned pattern.

Subsequently, the feature amount correcting unit 13 estimates a distribution 12 of the operation data corresponding to the unlearned pattern, using the feature amount of the distribution H1 of the estimated operation data corresponding to the learned pattern, the difference Δd between the estimated operation data corresponding to the learned pattern and the actually measured operation data, and the estimated operation data corresponding to the unlearned pattern (step ST4b). FIG. 9C is a graph illustrating a distribution of the operation data calculated in a process (3) of the correction processing using the physical model. The feature amount correcting unit 13 calculates the distribution 12, by interpolating between pieces of data of the distribution I1 including the actual measurement value of the operation data corresponding to the unlearned pattern, using both the feature amount of the distribution of the operation data which corresponds to the learned pattern and is estimated using the physical model and the difference Δd between the operation data estimated using the physical model and the actual measurement data.

The feature amount correcting unit 13 corrects the distribution 12 of the operation data corresponding to the unlearned pattern in such a way as to correspond to the learned pattern (step ST5b). FIG. 9D is a graph illustrating a distribution of the operation data calculated in a process (4) of the correction processing using the physical model. As illustrated in FIG. 9D, the feature amount correcting unit 13 generates a distribution 13 in which the average value μₜₑₛₜ in the distribution 12 of the estimated operation data corresponding to the unlearned pattern is replaced with the average value μtrain. The equipment state determining unit 14 compares the distribution H1 with the distribution 13, and determines the state of the equipment on the basis of the comparison result.

The number of pieces of operation data to be actually measured can be reduced by estimating the operation data of the equipment using the physical model.

A hardware configuration for implementing the functions of the equipment state monitoring device 1 is as follows.

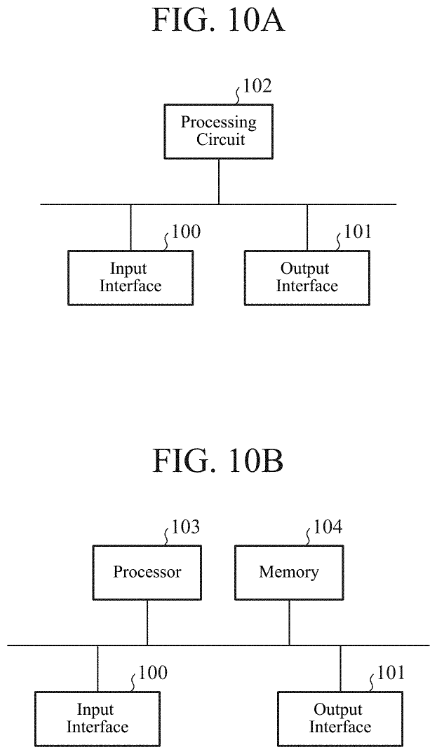

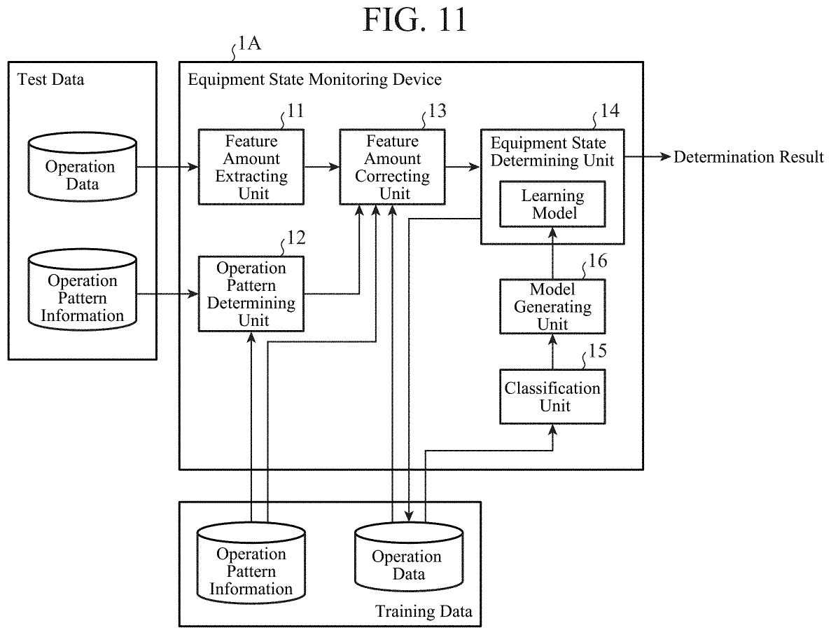

FIG. 10A is a block diagram illustrating a hardware configuration for implementing the functions of the equipment state monitoring device 1. FIG. 10B is a block diagram illustrating a hardware configuration for executing software for implementing the functions of the equipment state monitoring device 1. In FIGS. 10A and 10B, an input interface 100 is an interface that relays input of test data and training data for equipment. An output interface 101 is an interface that relays a determination result output from the equipment state determining unit 14 to the outside.

The functions of the feature amount extracting unit 11, the operation pattern determining unit 12, the feature amount correcting unit 13, and the equipment state determining unit 14 included in the equipment state monitoring device 1 are implemented by a processing circuit. That is, the equipment state monitoring device 1 includes a processing circuit for executing each of the processes from step ST1 to step ST4 illustrated in FIG. 2. The processing circuit may be dedicated hardware or a central processing unit (CPU) that executes a program stored in a memory.

In a case where the processing circuit is a processing circuit 102 of dedicated hardware illustrated in FIG. 10A, the processing circuit 102 corresponds to, for example, a single circuit, a composite circuit, a programmed processor, a parallel programmed processor, an application specific integrated circuit (ASIC), a field-programmable gate array (FPGA), or a combination thereof. The functions of the feature amount extracting unit 11, the operation pattern determining unit 12, the feature amount correcting unit 13, and the equipment state determining unit 14 included in the equipment state monitoring device 1 may be implemented by separate processing circuits, or these functions may be collectively implemented by one processing circuit.

In a case where the processing circuit is a processor 103 illustrated in FIG. 10B, the functions of the feature amount extracting unit 11, the operation pattern determining unit 12, the feature amount correcting unit 13, and the equipment state determining unit 14 included in the equipment state monitoring device 1 are implemented by software, firmware, or a combination of software and firmware. Note that, software or firmware is written as a program and stored in a memory 104.

The processor 103 reads and executes the program stored in the memory 104 to implement the functions of the feature amount extracting unit 11, the operation pattern determining unit 12, the feature amount correcting unit 13, and the equipment state determining unit 14 included in the equipment state monitoring device 1. For example, the equipment state monitoring device 1 includes the memory 104 that stores a program that, when executed by the processor 103, results in execution of each of the processes from step ST1 to step ST4 illustrated in FIG. 2. These programs cause a computer to execute procedures or methods performed by the feature amount extracting unit 11, the operation pattern determining unit 12, the feature amount correcting unit 13, and the equipment state determining unit 14. The memory 104 may be a computer-readable storage medium storing a program for causing a computer to function as the feature amount extracting unit 11, the operation pattern determining unit 12, the feature amount correcting unit 13, and the equipment state determining unit 14.

Examples of the memory 104 correspond to a nonvolatile or volatile semiconductor memory, such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, and a DVD.

A part of the functions of the feature amount extracting unit 11, the operation pattern determining unit 12, the feature amount correcting unit 13, and the equipment state determining unit 14 included in the equipment state monitoring device 1 may be implemented by dedicated hardware, and the remaining part may be implemented by software or firmware. For example, the function of the feature amount extracting unit 11 is implemented by the processing circuit 102 which is dedicated hardware, and each of the functions of the operation pattern determining unit 12, the feature amount correcting unit 13, and the equipment state determining unit 14 is implemented by the processor 103 reading and executing a program stored in the memory 104. Thus, the processing circuit can implement the above functions by hardware, software, firmware, or a combination thereof.

In the above description, the case where the equipment state monitoring device 1 acquires a learning model generated in advance and determines the state of the equipment has been described. However, the equipment state monitoring device 1 may include a component that generates a learning model. FIG. 11 is a block diagram illustrating a configuration of an equipment state monitoring device 1A which is a modification of the equipment state monitoring device 1. In FIG. 11, the same components as those in FIG. 1 are denoted by the same reference numerals, and redundant description is omitted. As illustrated in FIG. 11, the equipment state monitoring device 1A includes a feature amount extracting unit 11, an operation pattern determining unit 12, a feature amount correcting unit 13, an equipment state determining unit 14, a classification unit 15, and a model generating unit 16.

The classification unit 15 classifies pieces of operation data of equipment to be monitored into operation patterns. For example, the classification unit 15 classifies the pieces of operation data into the operation patterns, on the basis of a command value set to the equipment when each of the pieces of operation data included in the training data is measured from the equipment. Using the operation data classified for each operation pattern, the model generating unit 16 generates, for each operation pattern, a learning model that has learned the determination range of the state of the equipment. The equipment state determining unit 14 determines the state of the equipment using the corrected feature amount of the operation data and the learning model.

Note that the functions of the feature amount extracting unit 11, the operation pattern determining unit 12, the feature amount correcting unit 13, the equipment state determining unit 14, the classification unit 15, and the model generating unit 16 included in the equipment state monitoring device 1A are implemented by a processing circuit. That is, the equipment state monitoring device 1A includes a processing circuit for executing each of the processes including classification of operation data and generation of a learning model. The processing circuit may be the processing circuit 102 of dedicated hardware illustrated in FIG. 10A, or may be the processor 103 that executes the program stored in the memory 104 illustrated in FIG. 10B.

As described above, in the equipment state monitoring device 1 according to the first embodiment, the feature amount of the operation data of the equipment corresponding to the unlearned pattern is corrected in such a way as to correspond to the learned pattern on the basis of the relationship between the operation pattern of the equipment and the feature amount of the operation data, and the state of the equipment is determined on the basis of the corrected feature amount of the operation data and the determination range of the state of the equipment. As a result, the equipment state monitoring device 1 can determine the state of the equipment even using the operation data corresponding to the unlearned pattern.

Note that any component of the embodiment can be modified or any component of the embodiment can be omitted.

### INDUSTRIAL APPLICABILITY

The equipment state monitoring device according to the present disclosure can be used, for example, for monitoring a state of an industrial robot.

### REFERENCE SIGNS LIST

1, 1A: equipment state monitoring device, 11: feature amount extracting unit, 12: operation pattern determining unit, 13: feature amount correcting unit, 14: equipment state determining unit, 15: classification unit, 16: model generating unit, 100: input interface, 101: output interface, 102: processing circuit, 103: processor, 104: memory

1. An equipment state monitoring device, comprising:
feature amount extracting circuitry to extract a feature amount of operation data in which a state of equipment is measured;
operation pattern determining circuitry to determine whether an operation pattern of the equipment when the operation data of the equipment is measured is a learned pattern in which a determination range of a state of the equipment is learned or an unlearned pattern in which a determination range of a state of the equipment is not learned;
feature amount correcting circuitry to correct a distribution of the feature amount of the operation data corresponding to the operation pattern determined as the unlearned pattern in such a way as to get closer to and overlap with a distribution of a feature amount of operation data corresponding to the learned pattern on a basis of a relationship between one or more operation patterns of the equipment and one or more feature amounts of one or more pieces of operation data; and
equipment state determining circuitry to determine a state of the equipment on a basis of the corrected feature amount of the operation data of the equipment and a corresponding determination range of a state of the equipment.

2. The equipment state monitoring device according to claim 1, further comprising:
classification circuitry to classify the pieces of operation data of the equipment into the operation patterns; and
model generating circuitry to generate, for each of the operation patterns, a learning model that has learned a corresponding determination range of a state of the equipment, by using the pieces of operation data classified into the operation patterns, wherein
the equipment state determining circuitry determines a state of the equipment by using the corrected feature amount of the operation data and the learning model.

3. The equipment state monitoring device according to claim 1, wherein
the feature amount correcting circuitry learns the relationship between the operation patterns and the feature amounts of the pieces of operation data, and corrects the distribution of the feature amount of the operation data corresponding to the operation pattern determined as the unlearned pattern in such a way as to get closer to and overlap with the distribution of the feature amount of the operation data corresponding to the learned pattern on a basis of the learned relationship.

4. The equipment state monitoring device according to claim 1, wherein
the feature amount correcting circuitry estimates operation data of the equipment corresponding to the unlearned pattern using a physical model of the equipment, and corrects a distribution of a feature amount of the estimated operation data in such a way as to get closer to and overlap with the distribution of the feature amount of the operation data corresponding to the learned pattern on a basis of a relationship between the learned pattern and a feature amount of corresponding operation data.

5. An equipment state monitoring method, comprising:
extracting a feature amount of operation data in which a state of equipment is measured;
determining whether an operation pattern of the equipment when the operation data of the equipment is measured is a learned pattern in which a determination range of a state of the equipment is learned or an unlearned pattern in which a determination range of a state of the equipment is not learned;
correcting a distribution of the feature amount of the operation data corresponding to the operation pattern determined as the unlearned pattern in such a way as to get closer to and overlap with a distribution of a feature amount of operation data corresponding to the learned pattern on a basis of a relationship between one or more operation patterns of the equipment and one or more feature amounts of one or more pieces of operation data; and
determining a state of the equipment on a basis of the corrected feature amount of the operation data of the equipment and a corresponding determination range of a state of the equipment.
